(19) United States
(12) Patent Application Publication
(10) Pub. No.: US 2014/0298818 A1
(43) Pub. Date: Oct. 9, 2014

(54) CONTROL METHOD AND CONTROL DEVICE FOR LEAN FUEL INTAKE GAS TURBINE

(71) Applicant: KAWASAKI JUKOGYO KABUSHIKI KAISHA, Kobe-shi (JP)

(72) Inventors: Soh KUROSAKA, Kobe-shi (JP); Yoshihiro YAMASAKI, Kobe-shi (JP); Yasushi DOURA, Kobe-shi (JP)

(73) Assignee: KAWASAKI JUKOGYO KABUSHIKI KAISHA, Kobe-shi (JP)

(21) Appl. No.: 14/308,965

(22) Filed: Jun. 19, 2014

Related U.S. Application Data
(63) Continuation of application No. PCT/JP2012/080970, filed on Nov. 29, 2012.

(30) Foreign Application Priority Data
Dec. 21, 2011 (JP) 2011-279219

(51) Int. Cl. F02C 7/22

(52) U.S. Cl. CPC F02C 7/22
USPC 60/776; 60/734

(57) ABSTRACT

A method and a device for controlling a lean fuel intake gas turbine engine, which can stably maintain operation of the gas turbine engine by preventing misfire and burnout of a catalytic combustor even when a catalyst in the combustor is deteriorated. A difference between measured temperatures of an inlet and an outlet of the combustor with respect to a methane concentration in an intake gas that is to be taken into the lean fuel intake gas turbine engine is compared with reference temperature difference data that is data indicating difference between temperatures of the inlet and the outlet of the combustor including a catalyst in its initial state to be a reference, and at least one of the inlet temperature and the outlet temperature of the combustor is controlled based on a difference between the measured temperature difference and the reference temperature difference data.

### CROSS REFERENCE TO THE RELATED APPLICATION

This application is a continuation application, under 35 U.S.C. §111(a), of international application No. PCT/JP2012/080970, filed Nov. 29, 2012, which claims priority to Japanese patent application No. 2011-279219, filed Dec. 21, 2011, the disclosure of which are incorporated by reference in their entirety into this application.

### BACKGROUND OF THE INVENTION

1. Field of the Invention

The present invention relates to a method and a device for controlling a lean fuel intake gas turbine engine which utilizes, as a fuel, low-calorie gases such as CMM (Coal Mine Methane) and VAM (Ventilation Air Methane) generated in coal mines.

2. Description of Related Art

There has been proposed a lean fuel intake gas turbine engine which takes thereinto a mixture of CMM (Coal Mine Methane) generated in coal mines and VAM or air, and combusts, with a catalytic combustor, combustible components contained in the gas mixture (refer to Patent Document 1, for example).

### PRIOR ART DOCUMENT

[Patent Document 1] Japanese Laid-Open Patent Publication No. 2010-019247

### SUMMARY OF THE INVENTION

In the lean fuel intake gas turbine engine, if increase in temperature in the catalytic combustor is lowered due to deterioration of the catalyst, the catalyst inlet temperature is decreased via a heat exchanger. As a result, misfire of the catalytic combustor might occur, which makes it difficult to maintain the operation of the gas turbine engine. Meanwhile, since the fuel concentration continuously varies in the lean fuel intake gas turbine engine, if control to directly increase the flow rate of the fuel is performed when the inlet temperature of the catalytic combustor is decreased, supply of the methane as the combustible component becomes excessive, which might cause burnout of the catalyst.

An object of the present invention is to provide a method and a device for controlling a lean fuel intake gas turbine engine, which can stably maintain the operating state of the gas turbine engine by preventing misfire and burnout of a catalytic combustor even if the catalyst in the combustor of the gas turbine engine is deteriorated.

In order to achieve the above object, a method or a device for controlling a gas turbine engine according to the present invention is a method of controlling a lean fuel intake gas turbine engine which includes a catalytic combustor, and utilizes, as a fuel, a combustible component contained in a low-concentration methane gas, in which: a difference between measured temperatures of an inlet and an outlet of the combustor with respect to a methane concentration in an intake gas that is to be taken into the engine, is compared with reference temperature difference data that is data indicating difference between temperatures of the inlet and the outlet of the combustor having a catalyst in its initial state to be a reference, and at least one of an inlet temperature and an outlet temperature of the combustor is controlled based on a difference obtained by the comparison.

The control of the inlet temperature of the combustor may be performed as follows. That is, for example, the gas turbine engine is provided with a heat exchanger that heats a compressed gas introduced from a compressor to the combustor by use of an exhaust gas from a turbine, and a heat exchanger bypass valve that allows the compressed gas to bypass the heat exchanger and to be introduced into the combustor, and the inlet temperature of the combustor is increased by reducing an aperture of the heat exchanger bypass valve. Further, the control of the outlet temperature of the combustor may be performed as follows. That is, for example, a power converter is disposed between a power generator driven by the gas turbine engine and an external electric power system, and the outlet temperature of the combustor is controlled by reducing the rotation speed of the power generator via the power converter. According to the above configurations, the components required for operating the gas turbine engine are not greatly changed.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a block diagram showing a schematic structure of a gas turbine engine as a target to be controlled by a control method according to an embodiment of the present invention;

FIG. 2 is a flowchart showing the control method according to the embodiment of the present invention;

FIG. 3 is a block diagram showing a control logic of the control method shown in FIG. 2; and

FIG. 4 is a graph schematically showing temperature difference data used in the control method shown in FIG. 2.

### DESCRIPTION OF EMBODIMENTS

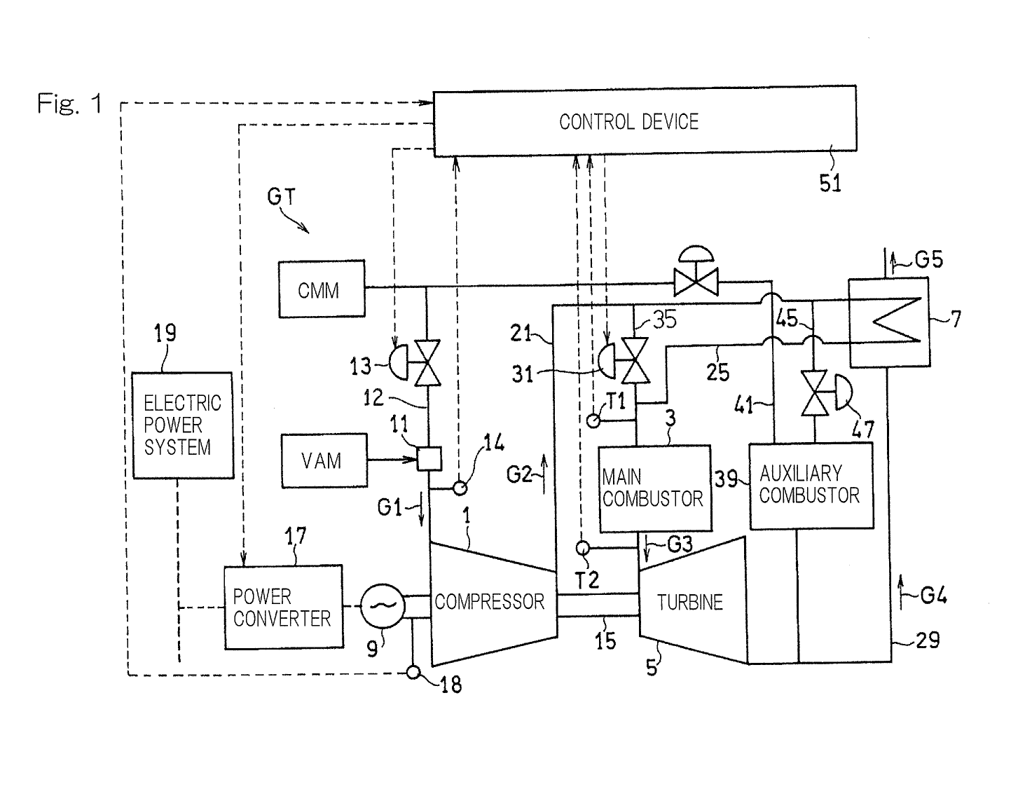

Hereinafter, embodiments of the present invention will be described with reference to the drawings. FIG. 1 is a block diagram schematically showing a gas turbine engine GT as a target to be controlled by a control method according to an embodiment of the present invention. The gas turbine engine GT includes a compressor 1, a main combustor 3 of a single-can type, a turbine 5, and a heat exchanger 7. A power generator 9 is driven by an output of the gas turbine engine GT.

The gas turbine engine GT according to the present embodiment is configured as a lean fuel intake gas turbine engine which intakes a mixture of low-calorie gas such as CMM (Coal Mine Methane) generated in coal mines and air or VAM (Ventilation Air Methane) discharged from coal mines, and utilizes, as a fuel, combustible components contained in the gas mixture. The main combustor 3 is configured as a catalytic combustor, including a catalyst such as platinum or palladium.

As low-calorie gases used in the gas turbine engine GT, for example, two types of fuel gases having respective fuel concentrations different from each other, such as VAM generated in coal mines and CMM higher in combustible component (methane) concentration than VAM, are mixed by a mixer 11 to prepare an intake gas G1, and the intake gas G1 is introduced into the gas turbine engine GT from an intake inlet of the compressor 1. The mixer 11 is provided on a fuel introducing passage 12, through which CMM from a CMM fuel source is introduced into the compressor 1. The flow rate of the CMM fuel is controlled by a CMM fuel control valve 13 provided upstream of the mixer 11 on the fuel introducing passage 12. A methane concentration meter 14 for measuring the methane concentration in the intake gas G1 is provided at the intake inlet of the compressor 1.

The intake gas G1 is compressed by the compressor 1 to generate a high-pressure compressed gas G2, and the compressed gas G2 is sent to the main combustor 3. The compressed gas G2 is combusted through catalytic reaction with an aid of the catalyst such as platinum or palladium in the main combustor 3 to generate a high-temperature and high-pressure combustion gas G3. The combustion gas G3 is supplied to the turbine 5 to drive the turbine 5. An inlet temperature sensor T1 and an outlet temperature sensor T2 are provided at an inlet and an outlet of the main combustor 3, respectively.

The turbine 5 is connected to the compressor 1 and the power generator 9 via a rotating shaft 15 so that the compressor 1 and the power generator 9 are driven by the turbine 5. A rotation detector 18 for detecting a rotation speed of the turbine 5 is provided on a portion of the rotating shaft 15 which extends between the compressor 1 and the power generator 9. The power generator 9 is connected to an external electric power system 19 via a power converter 17. The power converter 17 includes a circuit incorporated therein for mutual conversion between direct-current power and alternating current power, through which bi-directional power supply between the power generator 9 and the electric power system 19 may be performed.

The heat exchanger 7 heats the compressed gas G2 supplied from the compressor 1 to the main combustor 3 by using, as a heating medium, a turbine exhaust gas G4 discharged from the turbine 5. The compressed gas G2 from the compressor 1 is sent through a compressed gas passage 21 to the heat exchanger 7, heated in the heat exchanger 7, and then sent through a high-temperature compressed gas passage 25 to the main combustor 3. The turbine exhaust gas G4, having passed through the main combustor 3 and the turbine 5, flows into the heat exchanger 7 through a turbine exhaust gas passage 29. An exhaust gas G5 flowing out of the heat exchanger 7 is silenced through a silencer, which is not shown, and then discharged to the outside.

The compressed gas passage 21 and the high-temperature compressed gas passage 25 are communicated with each other via a heat exchanger bypass passage 35 having a heat exchanger bypass valve 31 provided thereon. In order to prevent the main combustor 3 from being excessively heated by the compressed gas G2 heated by the heat exchanger 7 and being burned, the heat exchanger bypass valve 31 is opened according to need to cause the compressed gas G2 to bypass the heat exchanger 7.

The gas turbine engine GT further includes an auxiliary combustor 39 in addition to the main combustor 3. The auxiliary combustor 39 warms up the heat exchanger 7 by supplying a high-temperature combustion gas to the heat exchanger 7, during a period from the startup of the gas turbine engine GT and before the main combustor 3 attains a predetermined working temperature. The auxiliary combustor 39 receives a fuel (for example, the CMM in the illustrated embodiment) supplied from an exclusive fuel supply passage 41, as well as a portion of the compressed gas G2 supplied from a start-up extraction passage 45 ramified from the compressed gas passage 21. A start-up extraction valve 47 is provided on the start-up extraction passage 45.

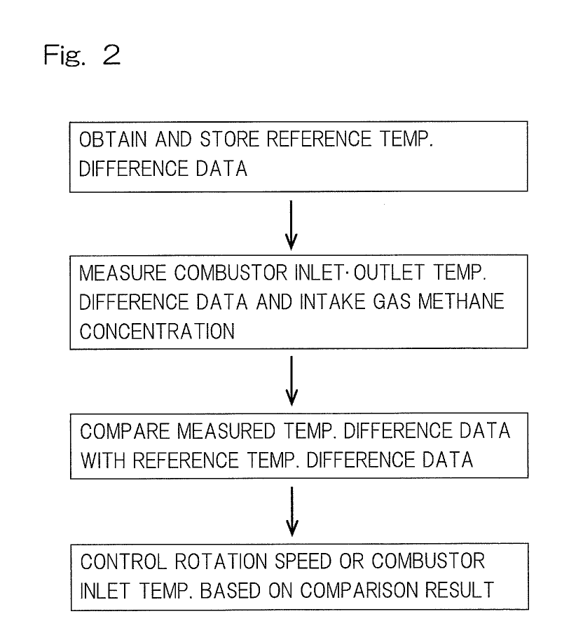

For the gas turbine engine GT having the above configuration, a control device 51 is provided which controls the gas turbine engine GT based on a difference between temperatures at the inlet and the outlet of the main combustor 3. Hereinafter, a method of controlling the gas turbine engine GT by the control device 51 will be described. In the control method according to the present embodiment, as shown in FIG. 2, a difference between measured temperatures of the inlet and the outlet of the main combustor 3, which is a catalytic combustor, with respect to a methane concentration of the intake gas G1 which is to be taken into the compressor 1 is compared with data indicating difference between temperatures of the inlet and the outlet of the main combustor 3 having a catalyst in its initial state to be a reference (hereinafter referred to as “reference temperature difference data”). Subsequently, at least one of the rotation speed of the gas turbine engine GT and the inlet temperature of the main combustor 3 is controlled based on a difference obtained by the comparison.

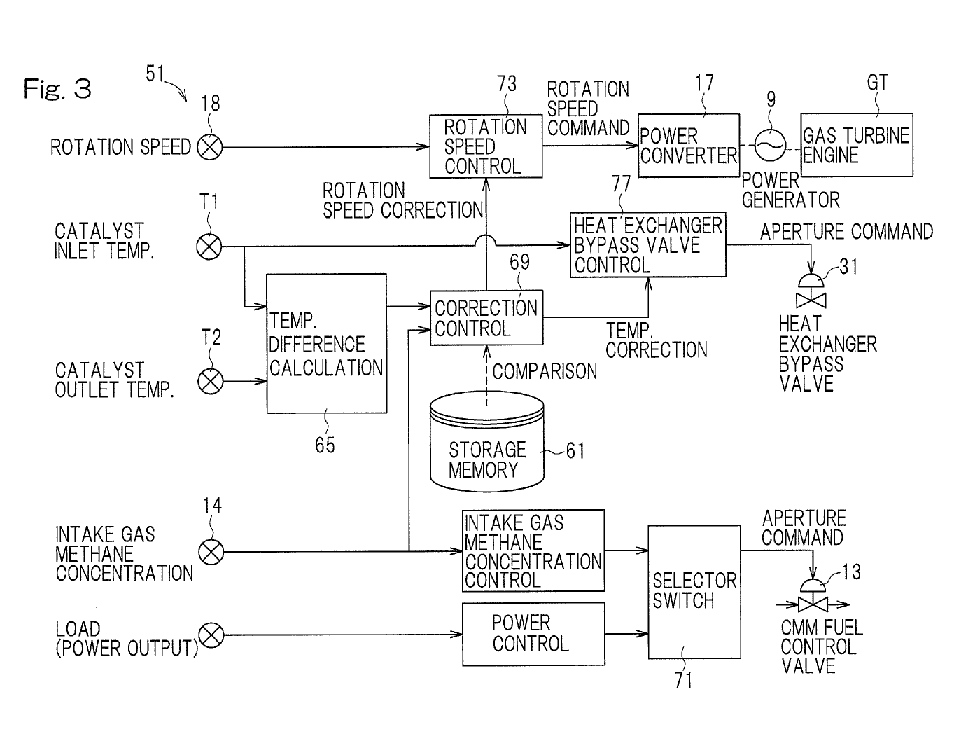

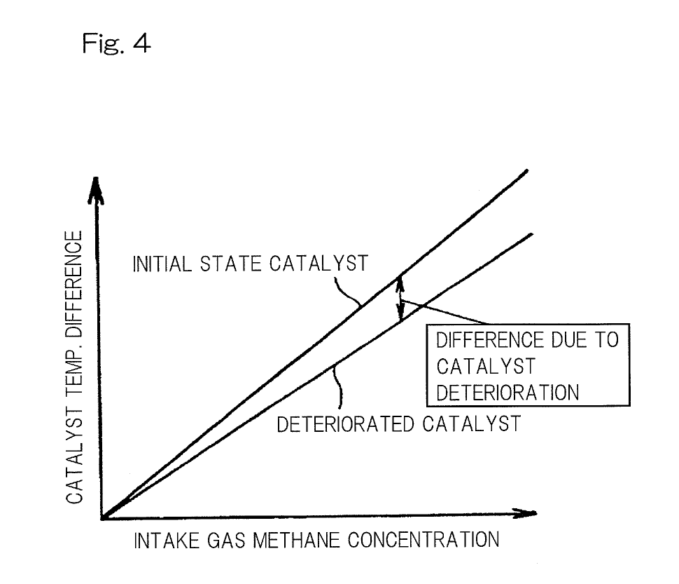

As shown in FIG. 3, the control device 51 includes a data storage memory 61 as a data storage section for storing therein the reference temperature difference data in advance. The reference temperature difference data is obtained by, for example, measuring in advance a difference between temperatures of the inlet and the outlet with respect to the methane concentration as shown in FIG. 4 by using the catalyst in its initial state.

Next, the temperature difference data is calculated by a temperature difference calculation section 65 from the measured values obtained by the inlet temperature sensor T1 and the outlet temperature sensor T2 shown in FIG. 3, and the temperature difference data (hereinafter referred to as “measured temperature difference data”) is compared in a correction control section 69 with the reference temperature difference data with respect to the methane concentration measured by the methane concentration meter 14. As deterioration of the catalyst progresses, the measured temperature difference is reduced. Therefore, a difference between the measured temperature difference data and the reference temperature difference data can be used as an index indicating the degree of deterioration of the catalyst. In other words, determination may be made that the larger the difference is, the more the deterioration of the catalyst progresses.

Based on the above-mentioned difference, the correction control section 69 controls the inlet temperature and the outlet temperature of the combustor 3. Specifically, in the present embodiment, the correction control section 69 corrects an aperture command value of a heat exchanger bypass valve control section 77 and a rotation speed command value of a rotation speed control section 73. When the aperture of the heat exchanger bypass valve 31 is reduced by correcting the aperture command value of the heat exchanger bypass valve control section 77, the flow rate of the compressed gas G2 passing through the heat exchanger 7 shown in FIG. 1 is increased, thereby increasing the inlet temperature of the main combustor 3.

On the other hand, upon receiving the command from the correction control section 69, the rotation speed control section 73 shown in FIG. 3 controls the rotation speed of the power generator 9 via the power converter 17 to control the rotation speed of the gas turbine engine GT. Specifically, the rotation speed of the gas turbine engine GT is reduced by reducing the rotation speed command value of the rotation speed control section 73, thereby reducing the flow rate of the gas flowing into the main combustor 3. In this way, the outlet temperature of the combustor 3 is prevented from being reduced.

It is noted that the correction control section 69 may be configured to control at least one of the inlet temperature and the outlet temperature of the main combustor 3. Further, instead of or in addition to the control of the rotation speed of the gas turbine engine GT by the rotation speed control section 73, the aperture of the start-up extraction valve 47 of the start-up extraction passage 45 shown in FIG. 1 may be adjusted to adjust the flow rate of the gas flowing into the main combustor 3, thereby controlling the outlet temperature of the combustor 3.

As described above, according to the gas turbine engine control method of the present embodiment, even if the catalyst in the main combustor 3 of the lean fuel intake gas turbine engine GT is deteriorated, misfire and burnout of the main combustor 3 can be prevented to stably maintain the operating state thereof.

It is noted that the control method according to the present embodiment is also effective in preventing misfire of the main combustor 3 when the load is reduced and in preventing burnout of the main combustor 3 when the load is increased. That is, in the main combustor 3 as a catalytic combustor, a combustion response delay to the supplied fuel occurs, and therefore, misfire might occur due to insufficient increase in the temperature of the catalyst when the load is reduced or, conversely, burnout of the catalyst might occur due to excessive increase in the temperature of the catalyst when the load is increased. However, if the catalyst deterioration correction control is applied when the load is reduced, the correction operation to increase the catalyst inlet temperature and reduce the rotation speed ensures a combustion state of the catalyst being kept stable. On the other hand, if the catalyst deterioration correction control is applied when the load is increased, the catalyst inlet temperature is reduced and the rotation speed is increased or the rated rotation speed is maintained, which is an operation reverse to the operation responding to deterioration. Thereby, burnout of the catalyst is prevented to ensure a combustion state of the catalyst being kept stable.

Further, if the methane concentration in the intake gas G1 is increased due to the operation for the correction control based on the degree of deterioration of the catalyst, the control for the CMM fuel control valve 13 may be switched to the control based on the methane concentration of the intake gas

G1 by using a selector switch 71, and the methane concentration in the intake gas G1 may be restricted so as not to exceed a specified value, thereby preventing explosion inside the compressor.

Although the present invention has been described above in connection with the embodiments thereof with reference to the accompanying drawings, numerous additions, changes, or deletions can be devised unless they depart from the gist of the present invention. Accordingly, such additions, changes, or deletions are to be construed as included in the scope of the present invention.

### REFERENCE NUMERALS

1 . . . Compressor

3 . . . Main combustor (catalytic combustor)

5 . . . Turbine

7 . . . Heat exchanger

17 . . . Power converter

31 . . . Heat exchanger bypass valve

51 . . . Control device

61 . . . Data storage section (data storage memory)

G1 . . . Intake gas

GT . . . Gas turbine engine

T1 . . . Inlet temperature sensor

T2 . . . Outlet temperature sensor

What is claimed is:

1. A method of controlling a lean fuel intake gas turbine engine which includes a catalytic combustor, and utilizes, as a fuel, a combustible component contained in a low-concentration methane gas, the method comprising:
comparing a difference between measured temperatures of an inlet and an outlet of the combustor with respect to a methane concentration in an intake gas that is to be taken into the engine, with reference temperature difference data that is data indicating difference between temperatures of the inlet and the outlet of the combustor having a catalyst in its initial state to be a reference, and
controlling at least one of an inlet temperature and an outlet temperature of the combustor based on a difference obtained by the comparison.

2. The control method as claimed in claim 1, wherein
the gas turbine engine is provided with a heat exchanger that heats a compressed gas introduced from a compressor to the combustor by use of an exhaust gas from a turbine, and a heat exchanger bypass valve that allows the compressed gas to bypass the heat exchanger and to be introduced into the combustor, and
the inlet temperature of the combustor is increased by reducing an aperture of the heat exchanger bypass valve.

3. The control method as claimed in claim 1, wherein
a power converter is disposed between an power generator driven by the gas turbine engine and an external electric power system, and
the outlet temperature of the combustor is controlled by reducing the rotation speed of the power generator via the power converter.

4. A device for controlling a lean fuel intake gas turbine engine which includes a catalytic combustor, and utilizes, as a fuel, a combustible component contained in a low-concentration methane gas, the device comprising:
a data storage section that stores therein reference temperature difference data that is data indicating difference between temperatures of the inlet and the outlet of the combustor having a catalyst in its initial state to be a reference, the reference temperature difference data being to be compared with a difference between measured temperatures of an inlet and an outlet of the combustor with respect to a methane concentration in an intake gas that is taken into the engine; and
a correction control section that compares the difference between measured temperatures of an inlet and an outlet of the combustor with respect to a methane concentration in an intake gas that is to be taken into the engine, with the reference temperature difference data, and controls at least one of an inlet temperature and an outlet temperature of the combustor based on a difference obtained by the comparison.

5. The control device as claimed in claim 4, wherein
the gas turbine engine is provided with a heat exchanger that heats a compressed gas introduced from a compressor to the combustor by use of an exhaust gas from the turbine, and a heat exchanger bypass valve that allows the compressed gas to bypass the heat exchanger and to be introduced into the combustor, and
the correction control section is configured to reduce an aperture of the heat exchanger bypass valve to increase the inlet temperature of the combustor.

6. The control device as claimed in claim 4, wherein
a power converter is disposed between a power generator driven by the gas turbine engine and an external electric power system, and
the correction control section is configured to reduce the rotation speed of the power generator via the power converter to control the outlet temperature of the combustor.
